(19) United States
(12) Patent Application Publication
(10) Pub. No.: US 2010/0200674 A1
(43) Pub. Date: Aug. 12, 2010

(54) CONFIGURABLE SPRINKLER SYSTEM WITH OPTIONAL WIRELESS DATA TRANSFER, AND METHODS OF CONSTRUCTING AND UTILIZING SAME

(76) Inventor: GREGORY J. EVERETT, Macomb Township, MI (US)

Correspondence Address: WEINER & BURT, P.C., 635 N US-23, POB 186, HARRISVILLE, MI, 48740, US

(21) Appl. No.: 12/417,587

(22) Filed: Apr. 2, 2009

Related U.S. Application Data
(63) Continuation-in-part of application No. 12/368,272, filed on Feb. 9, 2009.

(51) Int. Cl. B05B 3/02

(52) U.S. Cl. 239/222.11

(57) ABSTRACT

A configurable sprinkler system having a motorized valve that can be programmed for various spray patterns via an onboard memory chip and/or via an optional wireless data transfer.

### CROSS-REFERENCE TO RELATED APPLICATIONS

The present patent application is a continuation-in-part of U.S. patent application Ser. No. 12/368,272 filed on Feb. 9, 2009, the entire contents of which application are incorporated herein by reference thereto.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to a configurable sprinkler head and irrigation system, and methods of constructing and utilizing same.

More particularly, the present invention relates to a configurable spray pattern irrigation sprinkler in individual programmed output heads for sequential irrigation systems with optional wireless data transfer, and methods of constructing and utilizing same.

The prior, but not necessarily relevant, art is exemplified by:

Bonetti U.S. Pat. No. 4,265,403;

Beal U.S. Pat. No. 4,819,875; and

Kates U.S. Pat. No. 7,347,384.

It is a desideratum of the present invention to avoid the animadversions of conventional and present devices, and at the same time to provide a very efficient and easy to use configurable spray pattern sprinkler head apparatus, and methods of constructing and utilizing same.

### SUMMARY OF THE INVENTION

The present invention provides a configurable spray pattern irrigation sprinkler system with an optional wireless data transfer, comprising: an outer cup component; an inner rotating cylinder disposed in said outer cup component; a squirrel cage cylindrical compartment operatively connected to said inner rotating cylinder; a spray cap nozzle removable secured to said squirrel cage cylindrical compartment; a water inlet; first means operatively connected to said water inlet for controlling rotation of said inner rotating cylinder, water flow from said outer cup to said inner rotating cylinder, the timing, force and volume of water passing from said inner rotating cylinder into said squirrel cage compartment, and the timing, direction, force and volume of water sprayed out from said spray cap nozzle; said first means includes a motorized valve; onboard computer means for controlling said first means to produce a configurable spray pattern; a data transfer receiver; and whereby data for various shapes and dimensions of spray patterns is downloaded by an user to said first means via a software program usable with a laptop, handheld, or other computer data transfer device, or wireless data transfer via a broadcast similar to Bluetooth, Wi-Fi, or short range FM as a remote broadcast from a computer or a Bluetooth-capable cell phone or laptop computer.

It is a primary object of the present invention to provide a novel and unique configurable spray pattern irrigation sprinkler system as described hereinabove, and methods of constructing and utilizing same.

Another object of the present invention to provide an apparatus as described hereinabove which includes an optical reader that gives an eprom of the onboard computer means feedback as to the current positioning of the inner rotating cylinder of the spray direction any time the sprinkler is activated.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a schematic view of a first embodiment of the present invention.

FIGS. 2-6 illustrate some examples of spray patterns produced by the present invention.

### DETAILED DESCRIPTION OF THE INVENTION

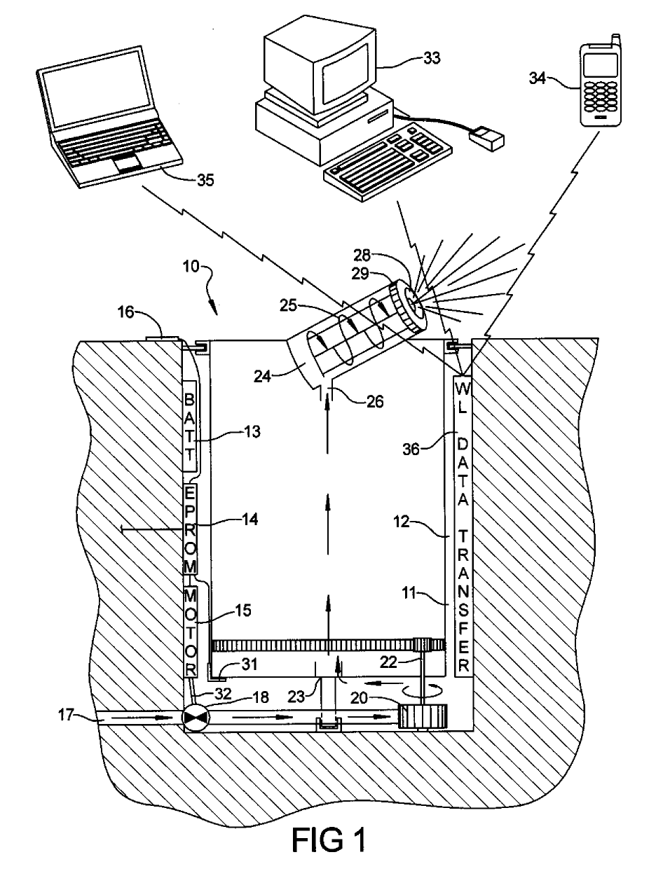

With reference to FIG. 1, the sprinkler head 10 consists of two major parts—the outer cup 11 and the inner rotating cylinder 12.

Components 11 and 12 are supported by a battery 13, an eprom 14, a motor 15, and a data transfer port 16 to program the eprom 14.

The functioning of the sprinkler head 10 will be described by following the flow of water from entry to exit.

The water pressure and volume is full and static at the water inlet 17, and being held back by the check ball valve 18 attached to the linear motor 15 via shaft 32.

When the programmed time and/or moisture limit programmed into the eprom 14 sends a signal to open the check ball valve 18, the water flows through an enclosed impeller 20 which is spline mounted with a gear 21 at opposite end of spline 22.

The gear 21 will turn the rotating cylinder 12 as water is eventually expelled for irrigation.

As the water moves through and exits the impeller 20, it travels from the outer cup 11 into the rotating cylinder 12 via a sealed watertight connection 23.

Water exiting the rotating cylinder 12 flows into a smaller cylindrical compartment 24 that contains a squirrel cage 25 which will rotate because the water entry orifice 26 is offset to one side of the squirrel cage cylinder 25.

The exit end of the squirrel cage 25 is capped with a nozzle 28 that is attached to the squirrel cage 25 and rotates with it.

Different nozzle caps 28, with different hole configurations are available for different mist and spray applications required by the landscape.

The squirrel cage 25 and end cap 28 are retained by a screw-on type retainer 29.

The rotating nozzle 28 with allow for variable type misting patterns from the sprinkler head 10 for predetermined distances, very short distances for spray pattern, etc.

An optical reader 31 gives the eprom 14 feedback as to the current positioning of the rotating cylinder 12 and the spray direction any time the sprinkler is activated so that the programming within the eprom 14 can control (via the linear motor 15) the amount of flow (and therefore pressure) at whatever position the rotating cylinder 12 is currently at.

If the current position calls for the maximum distance of spray distance, the eprom 14 would cause the motor 15 to open the check ball valve 18 to full open position and remain that way until the rotating cylinder 12 signals the eprom 14 its new position which may require a shorter spray distance.

The eprom 14 (checking downloaded data) would then close the check ball valve 18 according to shorten the distance of the spray.

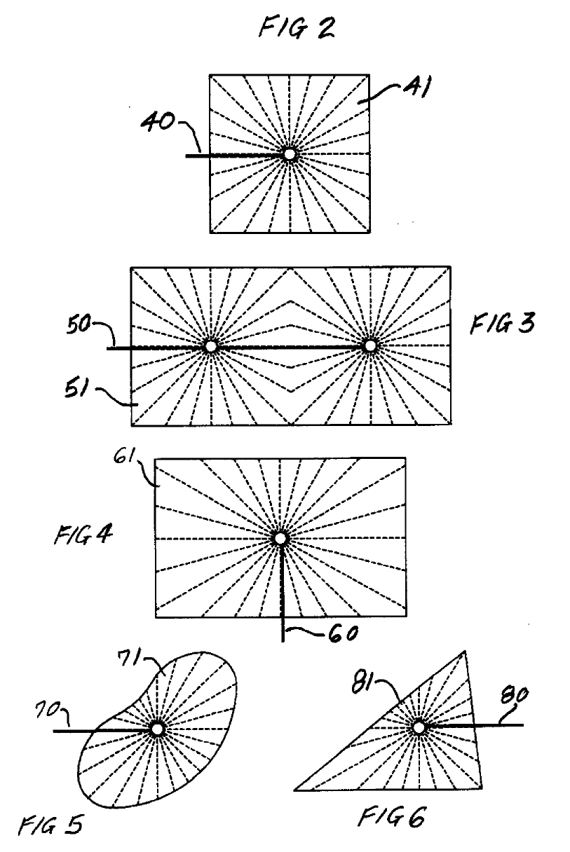

This allows the configuration of the sprinkler head 10 to cover areas in round, square, oval, elliptical, rectangle, or any shape to comport with the area being irrigated. Some of such covered areas are shown in FIGS. 2-6.

Data for area dimensions (to be irrigated) can be entered into a computer program specifically for the configurable sprinkler head 10 and downloaded:
to a portable media (such as flash media) and taken to the individual sprinkler head 10 and downloaded via the data transfer port 16; and/or
by a wireless data transfer receiver 36 via a broadcast similar to receiving Bluetooth, Wi-Fi, or short range FM as remote (broadcast) from a computer 33 or such as a Bluetooth-capable cell phone 34 or a laptop computer 35.

If the area dimensions change, the dimensions can be reloaded into the computer program and the reconfigured data re-downloaded to the sprinkler head 10, thereby customizing each sprinkler head 10 for the specific area coverage desired.

The present invention thus provides a configurable spray pattern irrigation sprinkler in individually programmed output head for sequential irrigation systems.

The invention provides an irrigation sprinkler head 10 in which the water flow is controlled at each head 10 by the electric motor 15 via the battery 13 and a microprocessor having an eprom microchip 14.

The purpose of controlling the water flow at each head 10 provides or allows for: individually timed and controlled flow of water at each head 10; sequential operation and thereby allowing simple installation design of irrigation for the area to be covered or irrigated; sprinkler head spray pattern to be configured and controlled via incremental opening and closing of water control valve 18 that is motor controlled; only that amount of water required to maintain healthy vegetation and no more than that; minimal underground piping; minimal number of sprinkler heads required to cover the given area; attachment of moisture probe 30 reading to override the turning on a sprinkler head 10 if ground moisture is adequate for optimum health and growth; pinpoint irrigation by each sprinkler head 10 as opposed to zones that cover much larger areas simultaneously and may over- or under-water the “zone” area; a moisture probe 30 reading to override sprinkler head 10 turning on during rain; eliminates need of underground zone valves; eliminates need for sequencing of larger to smaller underground piping for zoning; eliminates need of central zone control box and electrical power for box and zones valves; eliminates need of underground control wiring to each zone valve; and conservation of water by configuring spray pattern to the exact required dimensions to cover an area, as opposed to typical round spray patterns that must overlap to cover or leave unaltered areas between them.

The present invention thus provides sprinkler head 10 that consists of a nozzle 28 for spraying of water controlled by a motorized valve which through firmware embedded in a memory chip 14, and/or through wirelessly transferred data, can be programmed for various shapes of spray patterns, e.g., patterns 41, 51, 61, 71, 81 shown in FIGS. 2, 3, 4, 5, 6, respectively.

The patterns are downloaded by the user to the sprinkler via a software program usable with a laptop, handheld, or other computer data transfer device; or by an optional wireless data transfer receiver 36 via a broadcast similar to receiving Bluetooth, Wi-Fi, or short range FM as remote (broadcast) from a computer 33 or such as a Bluetooth-capable cell phone 34 or laptop computer 35.

The pattern is controlled by the linear motorized water control valve.

The valve in the full open position would give the greatest distance covered by the nozzle spray pattern, as the valve is moved to various less than full open positions, the nozzle spray pattern is shortened appropriate to the amount of water passing through the partially opened water control valve.

The increments the water valve can be opened and closed are extremely small and vary with the programming downloaded to each individual sprinkler unit 10.

The sprinkler head 10 can be programmed to produce a square pattern 41, rectangle 51 or 61, or any shape 71 or 81 in which the dimensions are known and input to the software program to configure and then be downloaded to the individual sprinkler head(s) 10 covering that particular area with those particular dimensions.

FIG. 2 show a water supply line 40 leading to a sprinkler head 10 producing a square-shaped spray pattern 41.

FIG. 3 shows a water supply line 50 leading to two sprinkler heads 10 producing an elongated rectangular shaped spray pattern 51.

FIG. 4 show a water supply line 60 leading to a sprinkler head 10 producing a rectangular-shaped spray pattern 61.

FIG. 5 show a water supply line 70 leading to a sprinkler head 10 producing a curved- or arcuate-shaped spray pattern 71.

FIG. 6 show a water supply line 80 leading to a sprinkler head 10 producing a triangular-shaped spray pattern 81.

With the onboard processor, the ability for a moisture sensor probe attachment 30 allows each sprinkler to not turn on during its given program time, if the ground immediately near the unit says there is already enough moisture in the ground. Thus, preventing sprinkler units turning on during or following a rain or for units that are in low laying areas of the landscape and require less watering than higher elevated areas of the landscape.

Since each sprinkler 10 has its own valve, it can be programmed to shut itself off regardless of the other sprinkler units in the system, without affecting the other sprinkler units.

Each sprinkler unit 10 can be programmed to open for the time sequence necessary for the desired output for the area which that particular sprinkler unit covers, and then shut itself off.

Each sprinkler 10 can therefore be programmed for the particular needs of each area covered by a particular sprinkler unit, avoiding over and under irrigation of particular areas within a given landscape. Including the ability to attach a moisture probe to the unit will prevent each unit from turning itself on when there is already enough moisture in the ground surrounding that individual unit, such as from rain, or being in a lower laying parcel of ground.

The ability to program each sprinkler unit to open and close its own water supply, allows for one size underground supply line to run through the entire landscape and by sequencing the individual sprinkler units on and off an entire landscape can be watered.

This eliminates the need for a timer controller, underground zone valves, underground wires to zone valves, the need for larger and then smaller underground water supply lines (zones—in typical installations) to distribute the water supply.

The configurable sprinkler unit 10 covers areas much more efficiently than the typical round spray pattern type unit, and also reduces the initial cost of installation.

A typical circular pattern sprinkler unit requires a plurality of sprinkler units to cover an area covered by one sprinkler 10.

A typical circular pattern sprinkler also produce areas of overlap or under-coverage depending how the user had configures the coverage.

Using configurable spray pattern sprinkler units 10 allows the use of fewer sprinklers units to cover the same amount of area covered by multiple typical circular spray pattern sprinkler units, while providing for better, more consistent, more even, coverage and providing water conservation.

Any and all changes, modifications, variations and other uses and applications of the present invention which do not depart from the spirit and scope of the present invention are covered by and embraced within the present invention and the patent claims set forth hereinbelow.

1. A configurable spray pattern irrigation sprinkler system with optional wireless data transfer, comprising:
an outer cup component;
an inner rotating cylinder disposed in said outer cup component;
a squirrel cage cylindrical compartment operatively connected to said inner rotating cylinder;
a spray cap nozzle removable secured to said squirrel cage cylindrical compartment;
a water inlet;
first means operatively connected to said water inlet for controlling rotation of said inner rotating cylinder, water flow from said outer cup to said inner rotating cylinder, the timing, force and volume of water passing from said inner rotating cylinder into said squirrel cage compartment, and the timing, direction, force and volume of water sprayed out from said spray cap nozzle;
said first means includes a motorized valve;
onboard computer means for controlling said first means to produce a configurable spray pattern;
a data transfer receiver; and
whereby data for various shapes and dimensions of spray patterns is downloaded by an user to said first means via a software program usable with a laptop, handheld, or other computer data transfer device, or wireless data transfer via a broadcast similar to Bluetooth, Wi-Fi, or short range FM as a remote broadcast from a computer or a Bluetooth-capable cell phone or laptop computer.

2. The system of claim 1, including:
a data transfer transmitter;
wherein said first means includes a check ball valve and a motor for controlling said check ball valve; and
said nozzle sprays water controlled by said motorized valve which, through firmware embedded in a memory chip, can be programmed for various shapes of spray patterns.

3. The system of claim 1 wherein said first means includes a water-driven impeller splined to a gear for rotating said inner rotating cylinder.

4. The system of claim 2 wherein said first means includes a water-driven impeller splined to a gear for rotating said inner rotating cylinder.

5. The system of claim 1 including a squirrel cage mechanism rotatably mounted within said squirrel cage compartment, and the water passing from said inner rotating cylinder into said squirrel cage compartment causes said squirrel cage mechanism to rotate.

6. The system of claim 2 including a squirrel cage mechanism rotatably mounted within said squirrel cage compartment, and the water passing from said inner rotating cylinder into said squirrel cage compartment causes said squirrel cage mechanism to rotate.

7. The system of claim 3 including a squirrel cage mechanism rotatably mounted within said squirrel cage compartment, and the water passing from said inner rotating cylinder into said squirrel cage compartment causes said squirrel cage mechanism to rotate.

8. The system of claim 4 including a squirrel cage mechanism rotatably mounted within said squirrel cage compartment, and the water passing from said inner rotating cylinder into said squirrel cage compartment causes said squirrel cage mechanism to rotate.

9. The system of claim 1 including an optical reader operatively connected with said inner rotating cylinder and said onboard computer means for detecting a current position of said inner rotating cylinder and for conveying said current position to said onboard computer means.

10. The system of claim 2 including an optical reader operatively connected with said inner rotating cylinder and said onboard computer means for detecting a current position of said inner rotating cylinder and for conveying said current position to said onboard computer means.

11. The system of claim 3 including an optical reader operatively connected with said inner rotating cylinder and said onboard computer means for detecting a current position of said inner rotating cylinder and for conveying said current position to said onboard computer means.

12. The system of claim 4 including an optical reader operatively connected with said inner rotating cylinder and said onboard computer means for detecting a current position of said inner rotating cylinder and for conveying said current position to said onboard computer means.

13. The system of claim 5 including an optical reader operatively connected with said inner rotating cylinder and said onboard computer means for detecting a current position of said inner rotating cylinder and for conveying said current position to said onboard computer means.

14. The system of claim 6 including an optical reader operatively connected with said inner rotating cylinder and said onboard computer means for detecting a current position of said inner rotating cylinder and for conveying said current position to said onboard computer means.

15. The system of claim 7 including an optical reader operatively connected with said inner rotating cylinder and said onboard computer means for detecting a current position of said inner rotating cylinder and for conveying said current position to said onboard computer means.

16. The system of claim 8 including an optical reader operatively connected with said inner rotating cylinder and said onboard computer means for detecting a current position of said inner rotating cylinder and for conveying said current position to said onboard computer means.

17. The system of claim 3 including a watertight sealed connection between said outer cup component and said inner rotating cylinder, and wherein said onboard computer means controls said motor, which in turn controls the flow of water to said water-driven impeller, which in turn rotates said inner rotating cylinder and causes water to flow from said outer cup component into said inner rotating cylinder through said watertight sealed connection.

18. The system of claim 4 including a watertight sealed connection between said outer cup component and said inner rotating cylinder, and wherein said onboard computer means controls said motor, which in turn controls the flow of water to said water-driven impeller, which in turn rotates said inner rotating cylinder and causes water to flow from said outer cup component into said inner rotating cylinder through said watertight sealed connection.

19. The system of claim 5 including a watertight sealed connection between said outer cup component and said inner rotating cylinder, and wherein said onboard computer means controls said motor, which in turn controls the flow of water to said water-driven impeller, which in turn rotates said inner rotating cylinder and causes water to flow from said outer cup component into said inner rotating cylinder through said watertight sealed connection.

20. The system of claim 16 including a watertight sealed connection between said outer cup component and said inner rotating cylinder, and wherein said onboard computer means controls said motor, which in turn controls the flow of water to said water-driven impeller, which in turn rotates said inner rotating cylinder and causes water to flow from said outer cup component into said inner rotating cylinder through said watertight sealed connection.
